(19) United States
(12) Patent Application Publication
(10) Pub. No.: US 2021/0403800 A1
(43) Pub. Date: Dec. 30, 2021

(54) ANTI-CAKING OR BLOCKING AGENT FOR TREATING SOLID ACID PRECURSOR ADDITIVES USED IN TREATING SUBTERRANEAN FORMATIONS

(71) Applicant: LYONDELLBASELL ADVANCED POLYMERS INC., Houston, TX (US)

(72) Inventors: BRADLEY L. TODD, DUNCAN, OK (US); STEVEN MEARL BURT, MARLOW, OK (US)

(73) Assignee: LYONDELLBASELL ADVANCED POLYMERS INC., HOUSTON, TX (US)

(21) Appl. No.: 17/355,984

(22) Filed: Jun. 23, 2021

Related U.S. Application Data
(60) Provisional application No. 63/043,591, filed on Jun. 24, 2020.

(51) Int. Cl. C09K 8/76; C09K 8/72

(52) U.S. Cl. CPC C09K 8/76; C09K 8/725

(57) ABSTRACT

Degradable material for treatment fluids for use in fluid loss control, diversion, and plugging operations, methods of preparing the degradable material, and methods of using the degradable material in treatment fluids are disclosed. The degradable materials are polymer-based solid acid precursor particles that have been partially or fully coated with an anti-caking agent to prevent agglomeration of the polymer-based solid acid precursor particles during storage and transport. These coated polymer-based solid acid precursor particles can then be added to a variety of treatment fluids to temporarily create a physical barrier to fluid flow before degrading and generating acids that can be used in other treatment operations. This degradable coated polymer-based solid acid precursor additive can be combined with other traditional downhole additives such surfactants, viscosifiers, and biocides, allowing for a wide variety of applications in hydrocarbon reservoirs.

### PRIOR RELATED APPLICATIONS

This application is the Non-Provisional Patent Application, which claims benefit of priority to U.S. Provisional Application No. 63/043,591, filed Jun. 24, 2020, the contents of which are incorporated herein by reference in their entirety.

### FEDERALLY SPONSORED RESEARCH STATEMENT

Not applicable.

### REFERENCE TO MICROFICHE APPENDIX

Not applicable.

### FIELD OF THE DISCLOSURE

The disclosure relates to treatment fluids and methods of use in hydrocarbon reservoirs, and more particularly to the pre-treatment of degradable materials in treatment fluids.

### BACKGROUND OF THE DISCLOSURE

Oil and gas companies are challenged to produce as much of their hydrocarbon reserves as possible in a cost-effective manner. As such, the completion and production processes often rely on the use of treatment fluids designed to resolve specific reservoir conditions through the use of one or more additives to increase hydrocarbon production.

The desired flow of the treatment fluid depends on the phase of the hydrocarbon recovery operations. During the producing (or injecting) phase of a well, it is generally desirable to have the subterranean formation as free flowing as possible or at a rate set by the design of the well. In contrast, it may be desirable to allow various fluids to flow into only a portion of the formation or wellbore while preventing flow into other portions during the drilling, completion, or workover phases. Unfortunately, the various treatment fluids may instead flow through vugs, pore spaces, and natural or manmade fractures in the formations, as well as other flow paths such as the wellbore, a well casing, perforation tunnels, slots, tubing, annuli, washouts, particulate packs, void spaces within sand and proppant packs, screens and completion, service, or workover equipment. As a result, the treatment fluids are often lost disproportionately to these high flow rate regions, reducing the efficiency of the treatment operation.

To overcome fluid lost, particulate material has been employed to bridge/seal/plug certain flow paths in the formations where the flow of fluids is undesirable. However, this material should temporarily block flow paths, such that these flow paths can be re-opened for subsequent operations.

Degradable materials of various types have been employed in subterranean operations for decades to temporarily block flow paths. For example, proppant packs have been created using proppant particulates and degradable materials so that, when the degradable material degrades, voids are formed in the proppant pack. Similarly, the degradable material may be introduced into the formation as part of the fluid that forms the filter cake, such that the filter cake contains the degradable material. Moreover, degradable materials may be used as a coating to temporarily protect openings in a coated object such as a tool until the opening is needed.

Advances have been made in developing degradable materials for blocking undesirable flow paths in reservoirs that also provide additional benefits that reduce the cost and steps in the subterranean operations. Polymer-based solid acid precursors, for example, have been added to treatment fluids to temporarily block flow paths, and participate in additional operations as they degrade and generate acid. The generated acid can be used for lowering fluid pH to break down gels in the fracturing fluid, etching surfaces of the formation to enlarge the channels, or facilitate degradation of acid soluble components injected into the formation, thus negating separate steps to perform these operations.

There still remains a need, however, to improve the stability of the degradable materials during storage, particularly polymer-based solid acid precursors. Different properties of the polymer-based solid acid precursors, such as molecular weight, non-crystallinity and additives to accelerate degradation, can be modified and adjusted to allow for a wide range of applications at a wide range of possible downhole temperatures. However, these design modifications can lead to stability issues during storage. As an example, some properties of polymer-based solid acid precursors that enable their use as faster degrading materials in low temperature will adversely affect the storage of these material in higher ambient temperature conditions.

Thus, there is a continued need for the development of storage-stable degradable materials that can be used to temporarily block flow paths in reservoirs around the world. Preferably, these improved degradable materials can also provide added benefits that reduce the cost and steps in the overall treatment operation.

### SUMMARY OF THE DISCLOSURE

Described herein are degradable materials for use in treatment fluids for a hydrocarbon reservoir, methods of making the degradable materials, and methods of using treatment fluids containing the degradable materials.

The degradable materials are polymer-based solid acid precursors that have been pre-treated with a powdered anti-caking agent to increase storage stability of the polymer-based solid acid precursor. In particular, the powdered anti-caking agent is applied to the outer surface of the polymer-based solid acid precursor particles. The coating prevents caking, fusing, or agglomeration of the polymer-based solid acid precursor particles when, for example, an acceleration additive is present in the particles or when the storage temperatures exceed the glass transition temperature of the polymer-based solid acid precursor. The degradable material can then be stored or transported to reservoirs, even during summer seasons around the world when ambient temperatures exceed 100° F., without the degradable material forming masses that are unable to be separated and/or are too large for injection. Thus, the degradable material will be readily available year-round for mixing into treatment fluids used in fracturing, acidizing, fluid loss control, diversion, and plugging operations in subterranean hydrocarbon reservoirs.

The present compositions and methods include any of the following embodiments in any combination(s) of one or more thereof:

A composition comprising at least one polymer-based solid acid precursor coated with an anti-caking agent.

A treatment fluid for treating a reservoir comprising at least one polymer-based solid acid precursor coated with an anti-caking agent.

Any of the compositions described herein, wherein the anti-caking agent is present in an amount of about 1 wt % to about 15 wt % of the composition.

Any of the compositions or treatment fluids described herein, wherein the anti-caking agent has a particle size between about 1 to about 100 microns.

Any of the compositions or treatment fluids described herein, wherein the anti-caking agent has a particle size between about 10 to about 30 microns.

Any of the compositions or treatment fluids described herein, wherein the anti-caking agent is a solid acid precursor.

Any of the compositions or treatment fluids described herein, wherein the anti-caking agent is a solid acid precursor comprising gluconolactone.

Any of the compositions or treatment fluids described herein, wherein the at least one polymer-based solid acid precursor has a particle size between about 100 microns to about 0.5 inches.

Any of the compositions or treatment fluids described herein, wherein the at least one polymer-based solid acid precursor is shaped as platelets, shavings, flakes, ribbons, rods, strips, spheroids, toroids, pellets, tablets, or any combinations thereof.

Any of the compositions or treatment fluids described herein, wherein the at least one polymer-based solid acid precursor is an aliphatic ester.

Any of the compositions or treatment fluids described herein, wherein the at least one polymer-based solid acid precursor is selected from a group consisting of poly(lactic acid) (PLA), polyglycolide (PGA), poly(ε-caprolactone) (PCL), poly(γ-valerolactone) (PVL), polyhydroxyalkanoate (PHA), polyhydroxybutyrate (PHB), and copolymers thereof.

Any of the compositions or treatment fluids described herein, wherein the at least one polymer-based solid acid precursor is an aliphatic ester.

Any of the compositions or treatment fluids described herein, wherein the anti-caking agent coats at least 10% of the outer surface of the at least one polymer-based solid acid precursor.

Any of the compositions or treatment fluids described herein, wherein the at least one polymer-based solid acid precursor is poly(lactic acid) and the anti-caking agent is gluconolactone.

Any of the treatment fluids described herein, wherein the treatment fluid further comprises at least one additive selected from a group including salts, viscosifying agents, pH control additives, surfactants, breakers, biocides, crosslinkers, additional fluid loss control agents, stabilizers, chelating agents, scale inhibitors, gases, mutual solvents, particulates, corrosion inhibitors, oxidizers, reducers, friction reducer, and any combination thereof.

Any of the treatment fluids described herein, wherein the at least one polymer-based solid acid precursor coated with an anti-caking agent is present in an amount between about 5 pounds per thousand gallons (pptg) and about 2000 pptg.

A method of using any of the treatment fluids described herein, wherein the methods includes the steps of injecting any of the treatment fluids described herein into a subterranean formation; blocking at least one opening in the subterranean formation with the at least one polymer-based solid acid precursor coated with an anti-caking agent; allowing the anti-caking agent and the at least one polymer-based solid acid precursor to degrade and generate acids; and flowing a fluid through the at least one opening. The method of using any of the treatment fluids described herein can further comprises steps such as injecting an aqueous fluid to selectively degrade the anti-caking agent and the at least one polymer-based solid acid precursor; etching surfaces of the formation with the generated acids; and/or degrading acid soluble components in the formation with the generated acids.

Any of the methods of using any of the treatment fluids described herein, wherein the opening being blocked by the at least one polymer-based solid acid precursor coated with an anti-caking agent is a vug, pore space, natural or manmade fractures in the formation, void spaces in particulate packs, within sand and proppant packs, screens, and completion, service, or workover equipment, or openings in a wellbore, a well casing, perforation tunnels, slots, ports, tubing, annuli, and washouts.

A method of forming any of the compositions described herein by admixing the anti-caking agent with the at least one polymer-based solid acid precursor in a fluidized bed and coating at least 10% of the outer surface of the polymer-based solid acid precursor particles with the anti-caking agent.

A method of forming any of the compositions described herein by adding the anti-caking agent to a ribbon blender through which the at least one polymer-based solid acid precursor is passed and coating at least 10% of the outer surface of the polymer-based solid acid precursor particles with the anti-caking agent.

A method of forming any of the compositions described herein by mixing the anti-caking agent with the at least one polymer-based solid acid precursor in a mixer and coating at least 10% of the outer surface of the polymer-based solid acid precursor particles with the anti-caking agent.

This summary is provided to introduce a selection of concepts that are further described below in the detailed description. This summary is not intended to identify key or essential features of the claimed subject matter, nor is it intended to be used as an aid in limiting the scope of the claimed subject matter.

### Definitions

As used herein, the term “solid acid precursor” refers to a degradable additive in a solid form that will generate an acid upon degradation. A “polymer-based solid acid precursor” is a polymer-based degradable additive in a solid form that will generate an acid upon degradation. Although these materials inherently generate acid on degradation, the term “solid acid precursor” is not meant to imply any particular functionality in the use of these materials as fluid placement agents.

As used herein, the term “irreversible” in reference to degradation means that the degradable material, once degraded, do not recrystallize or reconsolidate downhole.

As used herein, the term “treatment,” or “treating,” is intended to refer to any wellbore or subterranean operation that uses a fluid in conjunction with a desired function and/or for a desired purpose. The term “treatment,” or “treating,” is not intended to imply any particular action by the fluid or its components. Exemplary treatment fluids include, but are not limited to acidizing fluids, fracturing fluids, gravel packing fluids, drilling or milling fluids, lost circulation fluids, solvent fluids, chemical stimulation fluids, workover fluids, completion fluids, injection fluids, cleanout fluids, perforating fluids and kill fluids. Fluids may be aqueous- or oil-based, emulsions, foams, viscosified fluids, a gas, or any combination thereof.

As used herein, the term “fluid loss” refers to the undesirable migration or loss of fluids and/or slurry into a subterranean formation and/or a void space within the proppant pack.

The terms “hydraulic fracturing” and “fracking” are used interchangeably to refer to a well stimulation technique in which rock is fractured by a pressurized treatment fluid called a “fracturing fluid”. When the hydraulic pressure is removed from the well, small grains of hydraulic fracturing proppants (for example sand or aluminum oxide) hold the fractures open. The fracturing pressure of the treatment fluid is extremely high, up to 15,000 pounds per square inch, while the injection rate can be about 100 barrels per minute.

The term “acid treatment” is used to refer to a well stimulation technique in which acid treatment fluids are injected into a reservoir to dissolve reservoir rock or sediments, mud solids, and/or other soluble damage between the sediment grains of the reservoir rocks or flow paths. This treatment allows for the restoration of the natural productivity of the reservoir rock.

The terms “carrier fluid” and “base fluid” are used interchangeably to refer to a fluid that is used to transport materials into or out of the wellbore.

As used herein, the term “derivative” refers to a compound that is derived from a similar compound by a chemical reaction. The derived compound can be made by, for example, replacing one atom in the similar compound with another atom or group of atoms, rearranging two or more atoms in the similar compound, ionizing the similar compound, or creating a salt of the similar compound.

All concentrations herein are by weight percent (“wt %”) unless otherwise specified.

The use of the word “along” or “alongside” means extending in a more or less constant direction in relation to something else, such as a wellbore or fracture face.

As used herein, the term “coat” refers to a layer of anti-caking agent covering part of, and up to all of, the outer surface of the polymer-based solid acid precursor particle. Similarly, the terms “coating” or “coated” refer to an application of a layer to some or all of the outer surface of the polymer-based solid acid precursor particle. These terms are not intended to imply a specific amount of coverage of the outer surface polymer-based solid acid precursor particle, or mean that the outer surface of each polymer-based solid acid precursor particle is completely covered with the anti-caking agent, though some embodiments may require a complete covering.

As used herein, the term “anti-caking agent” refers to an additive placed in powdered or granulated materials, such as polymers, salts, cosmetics, and detergents, to prevent the formation of lumps (‘caking’), and for easing packaging, transport, and flowability.

The use of the word “a” or “an” when used in conjunction with the term “comprising” in the claims or the specification means one or more than one, unless the context dictates otherwise.

The term “about” means the stated value plus or minus the margin of error of measurement or plus or minus 10% if no method of measurement is indicated.

The use of the term “or” in the claims is used to mean “and/or” unless explicitly indicated to refer to alternatives only or if the alternatives are mutually exclusive.

The terms “comprise”, “have”, “include” and “contain” (and their variants) are open-ended linking verbs and allow the addition of other elements when used in a claim.

The phrase “consisting of” is closed, and excludes all additional elements.

The phrase “consisting essentially of” excludes additional material elements, but allows the inclusions of non-material elements that do not substantially change the nature of the invention.

The following abbreviations are used herein:

| ABBREVIATION | TERM |
|---|---|
| BHT | Bottom hole temperature |
| PCL | poly(ε-caprolactone) |
| PGA | polyglycolide |
| PHA | polyhydroxyalkanoate |
| PHB | polyhydroxybutyrate |
| PLA | poly(lactic acid) |
| ppg | Pounds per gallon |
| pptg | Pounds per thousand gallons |
| PVL | poly(γ-valerolactone) |

### Description of Embodiments of the Disclosure

The present disclosure provides novel degradable materials for use in treatment fluids for hydrocarbon reservoirs. In particular, degradable polymer-based solid acid precursors are pre-treated by applying a layer of an anti-caking agent to all or part of their outer surface to form coated polymer-based solid acid precursor particles. The anti-caking agent forms a protective layer that separates each particle of the polymer-based solid acid precursor such that the particles do not fuse or agglomerate when, for example, they are exposed to temperatures above the polymer-based solid acid precursor's glass transition temperature. This allows the coated polymer-based solid acid precursor additives to be stored under a variety of conditions and transported around the globe, and still be readily available for immediate use in treatment fluids. Methods of forming the degradable materials, and methods of using the degradable materials in treatment fluids are also described.

Polymer-based solid acid precursors such polylactic acid, polyglycolic acid and other aliphatic polyesters have been used as additives in many subterranean operations including stimulation, fluid loss control, lost circulation, diversion, and plugging operations. These additives come in a variety of shapes and sizes, allowing them to be modified or combined for the specific application such as use in fracturing fluids, acidizing fluids, drilling fluids, fluid loss control components, diverting agents, filter cake components, and cement additives. In the subterranean formation, the polymer-based solid acid precursor additives degrade and generate acid.

Once manufactured for the select subterranean operation, the polymer-based solid acid precursor additives are placed into storage containers and transported to a storage location prior to use in the reservoir. The transportation and storage present a problem, particularly during warmer months, because many of the polymer-based solid acid precursor additives have a glass transition temperature from about 110 to 150° F. (˜43-66° C.). Even in ambient environments, the temperatures within the storage containers can significantly exceed 125° F. When certain polymer-based solid acid precursor additives are heated to above their glass transition temperature, they agglomerate or fuse into masses that cannot be readily separated or are too large for injection into reservoirs, thus making the material unsuitable for use in subterranean formations. Polymer-based solid acid precursors with certain degradation acceleration additives are also susceptible to agglomerate or fusion into masses. While the polymer-based solid acid precursor additives could be transported and maintained under refrigerated storage conditions prior to usage, this would be very expensive and would prove either unfeasible or uneconomical for commercial usage, depending upon the storage or reservoir location.

To increase storage and transport stability, especially at temperatures above 100° F. (37° C.), and prevent caking and agglomerates of the polymer-based solid acid precursor additives, the presently disclosed methods pre-treat the polymer-based solid acid precursor additives with a powdered anti-caking agent. All or part of the outer surfaces of the polymer-based solid acid precursor particles are coated with the anti-caking agent after completion of the polymer-based solid acid precursor's manufacturing process, as a part of the polymer-based solid acid precursor's manufacturing process, or at any time prior to when the polymer-based solid acid precursor is expected to be exposed to storage or transportation temperatures which may, for example, exceed the glass transition temperature of the material.

The anti-caking coating does not interfere with the degradability of the polymer-based solid acid precursor additive. Thus, these novel degradable materials can be added to any treatment fluid that uses polymer-based solid acid precursor additive. In some embodiments, the anti-caking agent may also be a solid acid precursor that can generate acid in the formation and be used to perform other functions downhole.

In more detail, the novel degradable material can have:

Polymer-based solid acid precursor additive. The degradable material in the present disclosure has at least one polymer-based solid acid precursor additive that undergoes hydrolytic degradation. The degradable polymer-based solid acid precursor is capable of undergoing an irreversible degradation downhole in the reservoir, but is stable at storage and manufacturing temperatures.

The degradable polymer-based solid acid precursor is chosen such that its degradation rate complements the subterranean operation. The rates at which such polymers degrade are dependent on the type of repetitive unit, composition, sequence, length, molecular geometry, molecular weight, morphology (e.g., crystallinity, size of spherulites, and orientation), hydrophilicity, hydrophobicity, surface area, and additives. Also, the environment to which the polymer is subjected may affect how it degrades, e.g., reservoir temperature, type of treatment fluid, additives in the treatment fluid (such as enzymes), pH, and the like. As such, combinations of polymer-based solid acid precursors with different base polymers, different molecular weights, different additives and/or a variety of sizes and shapes may be employed to achieve a desired outcome for the subterranean operation.

Aliphatic polyesters are one such example of polymer-based solid acid precursor additives that degrade chemically by hydrolytic cleavage. Suitable examples of hydrolytically degradable aliphatic polyesters that may be used include, but are not limited to, those described in the publication of Advances in Polymer Science, Vol. 157 entitled “Degradable Aliphatic Polyesters” edited by A. C. Albertsson. Other suitable hydrolytically degradable polymers can be those made by polycondensation reactions, ring-opening polymerizations, free radical polymerizations, anionic polymerizations, carbocationic polymerizations, or coordinative ring-opening polymerization.

In some embodiments, aliphatic polyesters for use in the present compositions may have the general formula of repeating units shown in Formula 1.

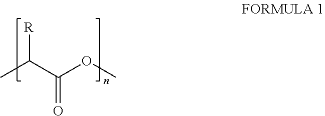

where n is an integer above 75, or between 75 and 10,000, and R is selected from the group consisting of hydrogen, alkyl, aryl, alkylaryl, acetyl, heteroatoms, and mixtures thereof. Alternatively, the solid acid precursor additives are homopolymers, random, block, graft, and star- and hyper-branched aliphatic polyesters. In yet another alternative, the aliphatic polyesters may be prepared by known manufacturing methods, including those described in U.S. Pat. Nos. 6,323,307; 5,216,050; 4,387,769; 3,912,692; and 2,703,316.

Examples of aliphatic polyesters for use in the present compositions include, but are not limited to poly(lactic acid) (PLA), also called poly(lactide), polyglycolide (PGA), poly(ε-caprolactone) (PCL), poly(γ-valerolactone) (PVL), polyhydroxyalkanoate (PHA), polyhydroxybutyrate (PHB), and copolymers thereof. In other embodiments, the aliphatic polyester is PLA. PLA is synthesized either from lactic acid by a condensation reaction or more commonly by ring-opening polymerization of cyclic lactide monomer. Since both lactic acid and lactide can achieve the same repeating unit, the general term poly(lactic acid) as used herein refers to esters without any limitation as to how the polymer was made such as from lactides, lactic acid, or oligomers, and without reference to the degree of polymerization.

Additionally, the form of the polymer used in the polymer-based solid acid precursor additive can be selected to control the degradation rate on different reservoir conditions. The lactide monomer in PLA, for example, exists in three different forms: two stereoisomers L- and D-lactide and racemic D,L-lactide (meso-lactide). The chirality of the lactide units provides a means to adjust degradation rates, as well as physical and mechanical properties. Poly(L-lactide) is a semicrystalline polymer with a relatively slow hydrolysis rate. Thus, it can be used in applications that need a slower degradation of the polymer-based solid acid precursor additive. In contrast, poly(D,L-lactide) is a more amorphous polymer with a faster hydrolysis rate. Thus, it may be suitable for applications where a more rapid degradation may be appropriate.

The stereoisomers of the chosen degradable polymer may be used individually or combined, or can be combined with other stereoisomers of other degradable polymers by blending, copolymerizing or otherwise mixing the stereoisomers. Additionally, the chosen degradable polymer may be copolymerized with, for example, glycolide, ε-caprolactone, 1,5-dioxepan-2-one, trimethylene carbonate, or other suitable monomers to produce degradable polymer-based solid acid precursor additives with different properties or degradation times.

In some embodiments, the novel degradable material includes polymer-based solid acid precursor additives with the same or different base polymer, and or particles with a variety of shapes and sizes. Different polymer-based solid acid precursor additives can be combined to enhance blocking of certain formation openings or to generate a variety of acids for subsequent operations.

The rate of hydrolysis can also be modified by the addition of components such as acids, bases, enzymes, or metal salts that can catalyze the degradation of the chosen polymer-based solid acid precursor additive in the formation.

Plasticizers may be present in the polymer-based solid acid precursor additives in an amount sufficient to provide desired characteristics for improved manufacturing of the solid material, for example, more effective compatibilization of the melt blend components or improved processing characteristics during the blending and processing steps. Examples of plasticizers include, but are not limited to, polyethylene glycol; polyethylene oxide; bis(butyl diethylene glycol)adipate; ethylphthalylethyl glycolate; glycerin diacetate monocaprylate; diacetyl monoacyl glycerol; polypropylene glycol (and epoxy derivatives thereof); poly(propylene glycol)dibenzoate, dipropylene glycol dibenzoate; glycerol; ethyl phthalyl ethyl glycolate; poly(ethylene adipate)distearate; di-iso-butyl adipate; and combinations thereof.

The polymer-based solid acid precursor additives may have any shape, depending on the desired characteristics of the degradable material, including but not limited to particles having the physical shape of platelets, shavings, flakes, ribbons, rods, strips, spheroids, toroids, pellets, tablets, or any other physical shape. Further, the size of the polymer-based solid acid precursor additives ranges from 100 microns to over 0.5 inches. Polymer-based solid acid precursor additives with different shapes and sizes may also be combined. The physical shape(s) and size(s) of the solid acid precursor additive can be chosen to enhance the function of the additive in the specific subterranean formation application in which it is being used.

Anti-caking agent. The novel degradable material further comprises an anti-caking agent for coating onto the outer surface of the degradable polymer-based solid acid precursor particles. As explained above, the anti-caking agent provide a protective coating by separating one particle of the polymer-based solid acid precursor additive from another to prevent fusion or agglomeration of the polymer-based solid acid precursor particles should the particles be exposed to temperatures that encourage such behavior.

The anti-caking agent does not need to entirely cover the outer surface of the polymer-based solid acid precursor particle to be effective at providing anti-caking capabilities. The anti-caking agent can coat at least 10% and up to 100% of the outer surface of the polymer-based solid acid precursor particle, depending on the size and shape of the polymer-based solid acid precursor particle.

The anti-caking agent is chosen such that it will not adversely react with the polymer-based solid acid precursor material or hinder its function when employed in a subterranean formation operation. Further, the anti-caking agent also does not adversely react with the reservoir formation and can be removed from the hydrocarbon reservoirs using the same methods for removing the polymer-based solid acid precursor additives.

The anti-caking agent is in a powdered form and has a particle size that allows it to readily adhere to the outer surface of the polymer-based solid acid precursor particle. The anti-caking agent may have a particle size in the range of about 1 to about 100 microns; alternatively, the particle size of the anti-caking agent may range from about 1 to about 40 microns; alternatively, the particle size of the anti-caking agent may range from about 60 to about 90 microns; alternatively, the particle size of the anti-caking agent may range from about 30 to about 70 microns; alternatively, the particle size of the anti-caking agent may range from about 10 to about 30 microns or about 60 to about 80 microns.

The amount of anti-caking agent will depend on the size and shape of the polymer-based solid acid precursor particle, and the amount of surface coverage. In some embodiments, the anti-caking agent may be present in an amount from about 1 to about 15 wt % of the coated particulate; alternatively, the anti-caking agent may be present in an amount from about 1 to about 10 wt % of the coated particulate; alternatively, the anti-caking agent may be present in an amount from about 8 to about 15 wt % of the coated particulate; alternatively, and more particularly about 5 to about 12 wt % of the coated particulate. However, larger quantities of the anti-caking agent may be present.

In some embodiments, the anti-caking agent is a solid acid precursor. Upon dissolution in an aqueous subterranean formation treatment fluid, this anti-caking solid acid precursor can assist in activation of the degradation reaction of the underlying polymer-based solid acid precursor additives. Further, solid acid precursor-based anti-caking agents are readily soluble in aqueous fluids and will not reprecipitate when in contact with subterranean formation fluids or materials. One such suitable solid acid precursor-based anti-caking agent can be gluconolactone. Gluconolactone can be partially hydrolyzed in the treatment fluid and hydrocarbon reservoir to form trace amounts of gluconic acid that can aid in the degradation of the polymer-based solid acid precursor agent. Other solid acid precursor-based anti-caking agents include the cyclic dimers of lactic acid and glycolic acid.

Methods of preparation. Any method for applying the anti-caking agent to the outer surface of the polymer-based solid acid precursor additives can be used to prepare the novel degradable material. The anti-caking agent may be applied onto the surface of the polymer-based solid acid precursor particles by admixing in a fluidized bed containing the polymer-based solid acid precursor additives. Alternatively, the anti-caking agent can be added to a ribbon blender through which the material is passed to admix and coat the anti-caking agent upon the surface of the polymer-based solid acid precursor particles. In yet another alternative, the polymer-based solid acid precursor particles are mixed with the powdered anti-caking agent in a mixer.

In yet other embodiments, a gluconolactone anti-caking agent is introduced into mixing equipment as a fine powder such that it may readily contact and coat upon the surface of the polymer-based solid acid precursor particles. Depending on the size and shape of the polymer-based solid acid precursor particles, as little as 10% of the surface may be coated with gluconolactone anti-caking agent to provided protection against fusion of the polymer-based solid acid precursor particles.

Applications. The novel degradable material can be used in any subterranean formation well treatment application in which a solid acid precursor is employed. The methods disclosed herein use the novel degradable material in many different types of treatment fluids for a variety of subterranean treatment operations including stimulation, fracking, acidizing, fluid loss control, lost circulation, diversion, and plugging operations. In some embodiments, these novel treatment fluid compositions comprising a carrier fluid and the coated polymer-based solid acid precursor additives, as well as other optional additives are used in subterranean operations.

For any of the method described herein, the treatment fluid has a carrier fluid that may be aqueous, non-aqueous, foamed, or an emulsion. This includes, but is not limited to, fresh water, salt water, brine (saturated salt water), seawater, produced water (subterranean formation water brought to the surface), surface water (such as lake or river water), and flow back water (water placed into a subterranean reservoir and then brought back to the surface). In some embodiments, the carrier fluid is selected from a group comprising fresh water, salt water, brine, and seawater. In other embodiments, the carrier fluid is brine.

A foamed treatment fluid may be desirable in certain methods to reduce the amount of fluid that is required in a water sensitive subterranean formation, to reduce fluid loss in the formation, and/or to provide enhanced proppant suspension. The foamed treatment fluid compositions can be foamed with any suitable gas, including nitrogen, carbon dioxide, air, or methane. The gas may be present in the range of from about 5% to about 98% by volume of the treatment fluid, and more preferably in the range of from about 20% to about 80% by volume of the treatment fluid. The amount of gas to incorporate in the fluid may be affected by many factors including the viscosity of the fluid and the bottom hole pressures involved in a particular application. Additional examples of foaming agents that may be used to foam and stabilize the treatment fluids include, but are not limited to, betaines, amine oxides, methyl ester sulfonates, alkylamidobetaines such as cocoamidopropyl betaine, alpha-olefin sulfonate, trimethyltallowammonium chloride, C8 to C22 alkylethoxylate sulfate and trimethylcocoammonium chloride. Other suitable foaming agents and foam stabilizing agents may be included as well, which will be known to those skilled in the art. However, one of ordinary skill in the art will recognize how much gas or other foaming agent, if any, to incorporate into foamed treatment fluids of the present composition for select operations.

The coated polymer-based solid acid precursor additives may be included in a treatment fluid having an unfoamed carrier fluid in an amount of about 5 pounds per thousand gallons (“pptg”) or as high as about 2000 pptg. Alternatively, the coated polymer-based solid acid precursor additive can be included in an unfoamed carrier fluid in an amount from about 5 pptg to about 500 pptg or about 400 pptg to about 900 pptg or about 750 pptg to about 1500 pptg or about 1200 pptg to about 2000 pptg. This relatively high loading of the coated polymer-based solid acid precursor additive allows for a sufficient quantity to act to plug a void/space, control fluid loss, or divert fluids as desired. Foamed carrier fluids will generally have reduced carrying capacity based, at least in part, on the density of the foam.

In some embodiments, the treatment fluid composition is injected into a wellbore penetrating a formation, wherein the carrier fluid carries the coated polymer-based solid acid precursor additives a distance from the location of the injection. The treatment fluid dissipates into the subterranean zone through openings or porous locations in the reservoir rock, which may be naturally occurring (cracks, fractures, and fissures) or man-made such as an annulus between nested pipes or between a wellbore and a pipe (wellbores, perforations, and fractures). As the treatment fluid is placed in the reservoir, the coated polymer-based solid acid precursor additives are screened out of the treatment fluid by the formation, or annulus, allowing it to be packed into the openings based on the size and shape of the coated polymer-based solid acid precursor additives. The packed coated polymer-based solid acid precursor additives can then be used as a fluid loss control agent, diverting agent, or plugging agent, directing additionally injected fluids to other areas of the reservoir or annulus until the novel degradable material degrade or are removed.

In some embodiments, the treatment fluid compositions are fracturing fluids and the novel degradable material is used as a fluid loss control agent. When used during the fracturing operation, this treatment fluid composition is injected at a pressure/rate sufficient to create or extend at least one fracture in that portion of the subterranean formation, wherein the carrier fluid places the novel degradable material into a portion of the fractured reservoir. The novel degradable material is then able to provide fluid loss control alongside the fracture faces.

For methods for diverting fluids, a treatment fluid having a diverting material is used to seal off a portion of the subterranean formation. The methods disclosed herein inject the novel treatment fluid compositions into the formation wherein the novel degradable material is the diverting material used to seal off a portion of the formation. The novel degradable material fills the largest pores, fissures, or vugs, until that portion of the formation is bridged and sealed. This allows for a second fluid to be diverted from the now sealed, highly permeable portions of the formation into the less permeable portions of the formation, or new zones, that require treatment. The steps of placing the novel degradable material and injecting a second fluid may be repeated until the desired number of stages of treating fluid has been pumped.

For methods for plugging operations, the coated polymer-based solid acid precursor additives are used as a plugging agent to seal off a well bore, providing zonal isolation. For this method, treatment fluid compositions using the coated polymer-based solid acid precursor additives are placed such that the coated polymer-based solid acid precursor additives seals the well bore face to prevent fluids from entering the permeable zones until the polymer-based solid acid precursor additives is removed or degraded. In some embodiments of the methods for plugging operations, it may be desirable to use the polymer-based solid acid precursor additives to completely fill a portion of an annulus along a well bore.

Alternatively, the novel degradable material described herein can be incorporated fluids for forming filter cakes or proppants packs, wherein the degradable material can degrade to an extent sufficient to loosen its packed particle density so that a subsequent flowing fluid can break up and flow out the remaining material.

Depending on the application of the treatment fluid with the coated polymer-based solid acid precursor additive, additional additives can be included to address other needs of the treatment fluid, the reservoir or the wellbore without affecting the ability of the coated polymer-based solid acid precursor additive to block or restrict openings or degrade.

For example, fracturing operations, frac-packing operations, and gravel packing operations, use a viscous solution to either place particulates or stimulate the formation. Thus, the treatment fluid compositions may further comprise viscosifiers and optional crosslinkers, in addition to the presently described degradable coated polymer-based solid acid precursor additive.

In some embodiments, the additional additives aid the coated polymer-based solid acid precursor additive in controlling fluid loss, diversion, or plugging. Alternatively, the additional additives are directed to other uses besides controlling fluid loss, diversion, or plugging. As such, the treatment fluids can further comprise optional additive including, but not limited to salts, pH control additives, surfactants, breakers, biocides, crosslinkers, additional fluid loss control agents, stabilizers, chelating agents, scale inhibitors, gases, mutual solvents, particulates, corrosion inhibitors, oxidizers, reducers, and any combination thereof.

Viscosifying agents and crosslinkers. Particularly in fracturing and gravel packing operations, it may be desirable to add a viscosifying agent to the treatment fluids described here. Suitable viscosifying agents may comprise any substance (e.g., a polymeric material) capable of increasing the viscosity of the treatment fluids. In certain embodiments, the viscosifying agent may comprise one or more polymers that are capable of forming a crosslink in a crosslinking reaction in the presence of a crosslinking agent, and/or polymers that have at least two molecules that are crosslinked (i.e., a crosslinked viscosifying agent). The viscosifying agents may be biopolymers, polysaccharides, and/or derivatives thereof that contain one or more of these monosaccharide units: galactose, mannose, glucose, xylose, arabinose, fructose, glucuronic acid, or pyranosyl sulfate. Examples of suitable viscosifying agents include, but are not limited to, cellulose derivatives, carboxymethylguars, carboxymethylhydroxyethylguars, carboxymethylhydroxypropylguars, hydroxyethylcelluloses, carboxyethylcelluloses, carboxymethylcelluloses, carboxymethylhydroxyethylcelluloses, diutan gums, xanthan gums, galactomannans, hydroxyethylguars, hydroxypropylguars, scleroglucans, wellans, starches (also known as polysaccharide gums), and any derivative and combination thereof.

The viscosifying agent may be present in an amount sufficient to provide the desired viscosity. In some embodiments, the viscosifying agents may be present in an amount in the range of from about 0.01% to about 10% by weight of the treatment fluid. In other embodiments, the viscosifying agents may be cellulose derivatives present in an amount in the range of from about 0.1% to about 1% by weight of the treatment fluid. In other embodiments, the viscosifying agents may be starches present in the range of from about 3% to 5% by weight of the treatment fluid. In other embodiments, the viscosifying agents may be polysaccharides present from about 0.1% to 3% by weight of the treatment fluid. In some embodiments the viscosifying agent may be a mixture of a polysaccharide and a starch (as used herein, the term “starch” refers to a polysaccharide gum).

In those embodiments of the treatment fluid where it is desirable to crosslink the viscosifying agent, the treatment fluid may comprise one or more crosslinking agents. The crosslinking agents may comprise a metal ion or similar component that is capable of crosslinking at least two molecules of the viscosifying agent. Examples of suitable crosslinking agents include, but are not limited to, magnesium ions, zirconium ions, titanium ions, aluminum ions, antimony ions, chromium ions, iron ions, copper ions, magnesium ions, and zinc ions. These ions may be provided by any compound that is capable of producing one or more of these ions as is well understood by those of skill in the art. Examples of such compounds include, but are not limited to, ferric chloride, magnesium oxide, zirconium lactate, zirconium triethanolamine, zirconium lactate triethanolamine, zirconium carbonate, zirconium acetylacetonate, zirconium malate, zirconium citrate, zirconium diisopropylamine lactate, zirconium glycolate, zirconium acetate lactate, zirconium triethanolamine glycolate, zirconium lactate glycolate, zirconium triisopropanolamine lactate, titanium lactate, titanium malate, titanium citrate, titanium ammonium lactate, titanium triethanolamine, and titanium acetylacetonate, aluminum lactate, aluminum citrate, aluminum acetate, antimony compounds, chromium(III) compounds, iron(II) compounds, iron(III) compounds, copper compounds, zinc compounds, and combinations thereof. In certain embodiments, the crosslinking agent may be formulated to remain inactive until it is “activated” by, among other things, certain conditions in the fluid (such as pH, temperature) and/or interaction with some other substance. In alternative embodiments, a crosslinking agent may be used wherein the ion-containing compounds is selected from the group consisting of ammonium zirconium carbonate, zirconium citrate, zirconium lactate citrate, zirconium oxide, titanium dioxide, aluminum nicotinate, aluminum sulfate, aluminum sodium sulfate, aluminum ammonium sulfate, chromium caseinate, chromium potassium sulfate, zinc sulfate, zinc hydrosulfite, magnesium chloride, magnesium sulfate, magnesium gluconate, copper sulfate, and copper gluconate.

Suitable crosslinking agents may be present in the treatment fluids in an amount sufficient to provide a desired degree of crosslinking between molecules of the viscosifying agent. In certain embodiments, the crosslinking agent may be present in an amount in the range of from about 0.005% to about 1% by weight of the treatment fluid. Alternatively, the crosslinking agent may be present in an amount in the range of from about 0.05% to about 0.1% by weight of the first treatment fluid and/or second treatment fluid.

While crosslinking agents may be added in a concentrated solution, the numerical ranges given above refer to the percentage of metal ions by weight of the treatment fluid. One of ordinary skill in the art will recognize the appropriate amount of crosslinking agent to include in a treatment fluid based on, among other things, the temperature conditions of a particular application, the type of viscosifying agents used, the molecular weight of the viscosifying agents, the desired degree of viscosification, and/or the pH of the treatment fluid.

It generally takes greater horsepower to pump fluids that are more viscous, especially when trying to place the fluids at substantial distances from the injection location. Thus, it may be desirable to delay the crosslink of the treatment fluids until the fluid is close to the area to be treated. Such delay allows the operator to pump a non-crosslinked (and thus less viscous) fluid over a longer distance before having to add horsepower to place the more viscous, crosslinked fluid. One skilled in the art will be familiar with known methods to delay crosslinking, such as encapsulation or chemical delays like chelating agents. In some embodiments, the activation of the crosslinking agent may be delayed by encapsulation with a porous coating through which the crosslinking agent may diffuse slowly or a degradable coating that degrades down hole. This coating delays the release of the crosslinking agent until a desired time or place.

Particulates. The treatment fluids described herein may further comprise additional optional particulates, including proppant particulates or gravel particulates. Such particulates may be included in the treatment fluids when a gravel pack is to be formed in at least a portion of the well bore, or a proppant pack is to be formed in one or more fractures in the subterranean formation.

Particulates suitable for use in the presently described treatment fluids and methods may comprise any material suitable for use in subterranean operations, including but not limited to, sand, bauxite, ceramic materials, glass materials, polymer materials, polytetrafluoroethylene materials, nut shell pieces, cured resinous particulates comprising nut shell pieces, seed shell pieces, cured resinous particulates comprising seed shell pieces, fruit pit pieces, cured resinous particulates comprising fruit pit pieces, wood, composite particulates, and combinations thereof Suitable composite particulates may comprise a binder and a filler material wherein suitable filler materials include silica, alumina, fumed carbon, carbon black, graphite, mica, titanium dioxide, calcium silicate, kaolin, talc, zirconia, boron, fly ash, hollow glass microspheres, solid glass, and combinations thereof.

The additional particulates described here are not limited to a particular shape. All known shapes of materials, including substantially spherical materials, fibrous materials, polygonal materials (such as cubic materials), and mixtures thereof can be used according to the application. For example, fibrous materials may or may not be used to bear the pressure of a closed fracture during a fracturing operation, but could be included in the fluid loss control operations. In some embodiments, the particulates may be coated with any suitable resin or tackifying agent known to those of ordinary skill in the art.

The mean particulate size for these additional particulates generally may range from about 2 mesh to about 400 mesh on the U.S. Sieve Series Scale. However, in certain circumstances, other mean particulate sizes may be desired and will be entirely suitable for practice of the presently described methods. In some embodiments, the mean particulate size distribution ranges are one or more of 6/12, 8/16, 12/20, 16/30, 20/40, 30/50, 40/60, 40/70, 50/70, or 70/140 mesh, or down to smaller sizes of 200 mesh and 10's of microns. The additional particulates may be present in the treatment fluids of the present invention in an amount in the range of from about 0.5 pounds per gallon (“ppg”) to about 30 ppg by volume of the treatment fluid.

pH Control. A pH control additive may be necessary to maintain the pH of the treatment fluid at a desired level to, for example, improve the effectiveness of certain breakers or crosslinkers. Examples of suitable pH control additives that may optionally be added to the treatment fluids of the present disclosure are bases and/or acid compositions. One of ordinary skill in the art will be able to recognize a suitable pH for a particular application.

Surfactants. In some embodiments, the treatment fluids of the present disclosure may include optional surfactants to improve the compatibility of the treatment fluids with other fluids (like any formation fluids) that may be present in the wellbore. One of ordinary skill in the art will be able to identify the type of surfactant as well as the appropriate concentration of surfactant to be used.

Suitable surfactants may be used in a liquid or powder form. Where used, the surfactants may be present in the treatment fluid in an amount sufficient to prevent incompatibility with formation fluids, other treatment fluids, or well bore fluids. In an embodiment where liquid surfactants are used, the surfactants are generally present in an amount in the range of from about 0.01% to about 5.0% by volume of the treatment fluid. In other embodiments, the liquid surfactants are present in an amount in the range of from about 0.1% to about 2.0% by volume of the treatment fluid. In embodiments where powdered surfactants are used, the surfactants may be present in an amount in the range of from about 0.001% to about 0.5% by weight of the treatment fluid.

Breakers. As mentioned above, the acid generated with the degradation of the anti-caking additive and/or the polymer-based solid acid precursor additive can be used to break gels. However, additional breakers may be added to the treatment fluids described herein.

Examples of breakers for use in the described treatment fluids include, but are not limited to, sodium chlorites, hypochlorites, perborate, persulfates, and peroxides (including organic peroxides). Other breakers include, but are not limited to, suitable acids and peroxide breakers, delinkers, as well as enzymes that may be effective in breaking viscosified treatment fluids. In some embodiments, the breaker may be citric acid, tetrasodium EDTA, ammonium persulfate, or cellulose enzymes.

A breaker may be included in an amount and form sufficient to achieve the desired viscosity reduction at a desired time. The breaker may be formulated to provide a delayed break or may be encapsulated. Suitable encapsulation methods are known to those skilled in the art. Exemplary encapsulation methods involves coating the selected breaker in a porous material that allows for release of the breaker at a controlled rate or coating the chosen breakers with a material that will degrade when downhole so as to release the breaker when desired. Resins that may be suitable include, but are not limited to, polymeric materials that will degrade when downhole.

Alternatively, the breakers may be encapsulated by synthetic and natural waxes. Waxes having different melting points may be used in order to control the delay of breaking based on the temperature of a specific subterranean operation. The encapsulation of the breaker is performed by mixing the breaker and wax above the melting temperature for the specific wax and then extruding the composition to form small particles of the encapsulated material. The resulting product may be annealed by briefly heating the product to the point of the coating to seal cracks in the coating, thus preventing premature release. The encapsulation may also be achieved by melt spraying the wax on the breaker particles or by any other technique known by a one of ordinary skill in the art. If used, a breaker should be included in a treatment fluid of the present invention in an amount sufficient to facilitate the desired reduction in viscosity in a treatment fluid. For instance, peroxide concentrations that may be used vary from about 0.1 to about 30 gallons of peroxide per 1000 gallons of the treatment fluid. Similarly, for instance, when citric acid is used as a breaker, concentrations of from 0.11 pptg to 30 pptg are appropriate.

An optional activator or retarder to can be used to, among other things, optimize the break rate provided by a breaker. Any known activator or retarder that is compatible with the selected breaker can be used in the present treatment fluids. Examples of activators include, but are not limited to, acid generating materials, chelated iron, copper, cobalt, and reducing sugars. Examples of retarders include sodium thiosulfate, methanol, and diethylenetriamine. One of ordinary skill will be able to identify a suitable activator or retarder for use with the selected breaker, and the proper concentration of such activator or retarder for a given application.

In some embodiments, the retarder or activator may be used in a range of from about 1 to about 100 pptg of treatment fluid or from about 5 to about 20 pptg.

One of ordinary skill will be able to identify a suitable activator or retarder for use with the selected breaker, and the proper concentration of such activator or retarder for a given application.

Because of the polymer-based solid acid precursors ability to be combined with a variety of known oil and gas treatment fluid additives without adverse effects to the polymer-based solid acid precursors' physical blocking abilities and the ability of its generated acids to participate in further treatment operations, the coated polymer-based solid acid precursors can be used in a variety of applications, including stimulation, fluid loss control, diversion, and plugging operations.

Further, the degradable material can be a combination of different polymer-based solid acid precursors and/or polymer-based solid acid precursors with a variety of shape such that the degradable material degrades over a period ranging from a few days to a few weeks at bottom hole temperatures (BHT) of at least 140° F. (60° C.).

In addition to allowing the coated polymer-based solid acid precursor additive to degrade natural and generate acid, methods of selectively degrading the coating and/or polymer-based solid acid precursor additive in situ can also be performed. Many subterranean operations rely on the ability to control and/or design a fluid composition with prespecified rates and durations for degradation and removal of the degradable coated polymer-based solid acid precursor additive to accomplish timed events or functions in order to minimize waiting-on-degradation time, and begin other operations that depend on the generated acids.

In some embodiments, methods to accelerate the reactions with water to degrade the coating and/or polymer-based solid acid precursor additive at the end of an operation in a controlled and predictable manner will be performed. For example, an aqueous media can be injected to degrade a coated PLA-based solid acid precursor additive after the PLA additive has performed the intended function or because its degradation products are needed perform a function. In other embodiments, the anti-caking agent and the polymer-based solid acid precursor additive can be selectively degraded and/or removed using the same methods.

The following examples are included to demonstrate the ability of an anti-caking agent to prevent caking of polymer-based solid acid precursor additives at temperatures at or above the polymer's glass transition temperature. In these examples, particulate gluconolactone was chosen as the anti-caking agent. These examples are intended to be illustrative, and not unduly limit the scope of the appended claims. Those of skill in the art should appreciate that many changes can be made in the specific embodiments which are disclosed herein and still obtain a like or similar result without departing from the spirit and scope of the disclosure herein. In no way should the following be read to limit, or to define, the scope of the appended claims.

### EXAMPLES

The caking of a polymer-based solid acid precursor additive coated with particulate gluconolactone under various storage conditions was measured. The polymer-based solid acid precursor additive was amorphous PLA particles with a particle size between about 2350 to about 3350 microns (6/8 mesh on the U.S. Sieve Series Scale).

In each example, an amorphous PLA particles with a glass transition temperature of less than 110° F. (˜38° C.) was admixed with gluconolactone particulates. Example 1 utilized unground gluconolactone having an average particle size of about 100 to 800 microns. Examples 2-6 utilized gluconolactone that was ground to a particle size of between 1 and 100 microns. For each example, a rotating blender was used to thoroughly coat the amorphous PLA particles with the gluconolactone.

For each example, the coated material was placed in a test cell under a positive pressure of 1 PSI to simulate the pressure that would be exerted on the polymer-based solid acid precursor additive if it was in the bottom bag of a pallet of bags of the additive. The test cell was then placed in an autoclave maintained at the test temperature for predetermined amounts of time. A ‘pass/fail’ determination regarding caking was then made after removal of the test cell from the autoclave. The results are shown in Table 1

TABLE 1
Caking of the amorphous polylactic acid at various temperatures

| | Test Temperature | Test Time | |
|---|---|---|---|
| Material | (° F.) | (hr) | Pass/Fail |
| Example 1 | 110 | 24 | Failed - caking |
| Example 2 | 110 | 24 | Passed - no caking |
| Example 3 | 110 | 66 | Passed - no caking |
| Example 4 | 116 | 24 | Passed - no caking |
| Example 5 | 135 | 24 | Passed - no caking |
| Example 6 | 140 | 24 | Passed - no caking |

The results shown in Table 1 demonstrate the effectiveness of gluconolactone with particle sizes between 1 and 100 microns in preventing caking of the solid acid precursor additive when exposed to storage conditions that exceed the glass transition temperature of the PLA particles. Thus, the present compositions will be storage stable while awaiting use in subterranean formation treatments. This allows the coated solid acid precursor additives to be transported around the world regardless of climate temperatures and immediately available for a variety of operations downhole, including fracturing, acidizing, fluid loss control, diversion, and plugging operations.

1. A composition comprising at least one polymer-based solid acid precursor coated with an anti-caking agent.

2. The composition of claim 1, wherein said anti-caking agent has a particle size between about 1 to about 100 microns.

3. The composition of claim 2, wherein said anti-caking agent has a particle size between about 10 to about 30 microns.

4. The composition of claim 1, wherein said anti-caking agent is a solid acid precursor.

5. The composition of claim 4, wherein the solid acid precursor comprises gluconolactone.

6. The composition of claim 1, wherein said at least one polymer-based solid acid precursor has a particle size between about 100 microns to about 0.5 inches.

7. The composition of claim 1, wherein said at least one polymer-based solid acid precursor is shaped as platelets, shavings, flakes, ribbons, rods, strips, spheroids, toroids, pellets, tablets, or any combinations thereof.

8. The composition of claim 1, wherein said at least one polymer-based solid acid precursor is an aliphatic ester.

9. The composition of claim 8, wherein said aliphatic ester is selected from a group consisting of poly(lactic acid) (PLA), polyglycolide (PGA), poly(ε-caprolactone) (PCL), poly(γ-valerolactone) (PVL), polyhydroxyalkanoate (PHA), polyhydroxybutyrate (PHB), and copolymers thereof.

10. The composition of claim 1, wherein the anti-caking agent is present in an amount of about 1 wt % to about 15 wt % of the composition.

11. The composition of claim 1, wherein the anti-caking agent coats at least 10% of the outer surface of the at least one polymer-based solid acid precursor.

12. The composition of claim 1, wherein the at least one polymer-based solid acid precursor is poly(lactic acid) and the anti-caking agent is gluconolactone.

13. A treatment fluid for treating a reservoir, said treatment fluid comprising:
a) a carrier fluid; and
b) at least one polymer-based solid acid precursor coated with an anti-caking agent.

14. The treatment fluid of claim 13, further comprising at least one additive selected from a group comprising salts, viscosifying agents, pH control additives, surfactants, breakers, biocides, crosslinkers, additional fluid loss control agents, stabilizers, chelating agents, scale inhibitors, gases, mutual solvents, particulates, corrosion inhibitors, oxidizers, reducers, friction reducer, and any combination thereof.

15. The treatment fluid of claim 13, wherein said at least one polymer-based solid acid precursor coated with an anti-caking agent is present in an amount between about 5 pounds per thousand gallons (pptg) and about 2000 pptg.

16. The treatment fluid of claim 13, wherein the at least one polymer-based solid acid precursor is poly(lactic acid) and the anti-caking agent is gluconolactone.

17. A method of using the treatment fluid of claim 13, comprising
a) injecting the treatment fluid of claim 13, into a subterranean formation;
b) blocking at least one opening in said subterranean formation with the at least one polymer-based solid acid precursor coated with an anti-caking agent; and
c) allowing the anti-caking agent and the at least one polymer-based solid acid precursor to degrade and generate acids; and,
d) flowing a fluid through the at least one opening.

18. The method of claim 17, further comprising the step of etching surfaces of the formation with the generated acids.

19. The method of claim 17, further comprising the step of degrading acid soluble components in the formation with the generated acids.

20. The method of claim 17, further comprising the step of injecting an aqueous fluid to selectively degrade the anti-caking agent and the at least one polymer-based solid acid precursor.
